(19) United States
(12) Patent Application Publication
(10) Pub. No.: US 2025/0083079 A1
(43) Pub. Date: Mar. 13, 2025

(54) FILTER DEVICE, FILTER ELEMENT, CONFIGURATION OF A FILTER ELEMENT, AND METHOD FOR IDENTIFYING A FILTER ELEMENT

(71) Applicant: ARGO-HYTOS GROUP AG, Baar (CH)

(72) Inventors: Thomas WEISER, Rauenberg (DE); Valentin PICHLMAIER, Heilbronn (DE)

(21) Appl. No.: 18/956,737

(22) Filed: Nov. 22, 2024

Related U.S. Application Data
(63) Continuation of application No. PCT/EP2023/063503, filed on May 19, 2023.

(30) Foreign Application Priority Data
Jun. 3, 2022 (DE) 10 2022 114 122.5

(51) Int. Cl. B01D 35/30; B01D 29/96

(52) U.S. Cl. CPC B01D 35/30; B01D 29/96; B01D 2201/291; B01D 2201/34

(57) ABSTRACT

A filter device for filtering fluids, in particular for filtering hydraulic oil, contains a filter housing, at least one filter cover, and at least one filter element which is arranged replaceably in the filter housing. The filter element has a carrier portion with at least one data store, wherein identity data for in particular identifying the filter element are stored in the data store and can be read wirelessly from the data store by a read and/or write unit. The carrier portion extends at least partially through a passage opening in the filter housing and/or filter cover, wherein the data store arranged on or in the carrier portion.

### CROSS-REFERENCE TO RELATED APPLICATION

This application is a continuation, under 35 U.S.C. § 120, of copending International Patent Application PCT/EP2023/063503, filed May 19, 2023, which designated the United States; this application also claims the priority, under 35 U.S.C. § 119, of German Patent Application DE 10 2022 114 122.5, filed Jun. 3, 2022; the prior applications are herewith incorporated by reference in their entirety.

### FIELD AND BACKGROUND OF THE INVENTION

The invention relates to a filter device for filtering fluids, in particular for filtering hydraulic oil. The invention furthermore relates to a filter element for a filter device, to an arrangement of a filter device and a read and/or write unit, and to a method for identifying a filter element. A filter device of the type mentioned at the beginning is known, for example, from published, non-prosecuted German patent application DE 10 2004 054 172 A1, corresponding to U.S. patent publication No. 2008/0060983.

Filter devices with filter elements are generally used to filter liquid or gaseous media. Such filter devices can be suction filters, return filters, pressure filters, or return-suction filters which are used primarily in a mobile hydraulic system. The filter elements are usually adapted to the respective use case and consequently differ in numerous parameters.

If, for example, a filter element is damaged or the maximum lifetime of the filter element has been reached, this filter element is usually replaced by a new functional filter element. There is therefore the fundamental risk that an unsuitable filter element is installed in an existing filter device. It is moreover not out of the question that installation of a new filter element is forgotten after the used filter element has been removed. In both cases, serious damage can be caused to the machine with the connected filter device such that operational safety is compromised.

In order to detect an unsuitable or missing filter element, it is known to provide in the filter element a data store with identity data of the filter element. The filter element installed in the filter device can be identified by reading these data by means of a suitable read unit without it being necessary to disassemble the filter device.

Published, non-prosecuted German patent application DE 10 2004 054 172 A1 describes such a filter element which is arranged in a filter housing. The filter element has a closure disk in which a data store is provided. Data which specify the filter element are stored in the data store. A read unit is arranged on the outside of the filter housing. This read unit reads the data from the data store wirelessly and thus identifies the filter element. The filtered fluid flows during operation between the read unit and the data store. The in particular high-temperature fluid can thus have a negative effect when the data are read from the data store and hence compromise operational safety.

### SUMMARY OF THE INVENTION

The object of the present invention is therefore to improve a filter device of the type mentioned at the beginning such that the operational safety is increased. The invention is furthermore based on the object of supplying a filter element for a filter device, an arrangement of a filter device and a read and/or write unit, and a method for identifying a filter element.

According to the invention, this object is achieved by a filter device according to the independent filter device claim and a filter element according to the independent filter element claim, an arrangement according to the independent arrangement claim, and a method for identifying a filter element according to the independent method claim.

Specifically, the object is achieved according to the invention by a filter device for filtering fluids, in particular for filtering hydraulic oil, containing a filter housing, at least one filter cover, and at least one filter element which is arranged replaceably in the filter housing. The filter element has a carrier portion with at least one data store, wherein identity data for in particular identifying the filter element are stored in the data store and can be read wirelessly from the data store by means of a read and/or write unit. The carrier portion extends when in use at least partially through a passage opening in the filter housing and/or the filter cover. The data store is arranged on or in the carrier portion.

The present invention thus takes a different approach from the prior art which uses conventional closure disks to hold the data store. Instead, a carrier portion which extends at least partially through a passage opening in the filter housing and/or the filter cover is provided for this purpose. A read and/or write unit can thus be arranged during use at the outside of this passage opening in order to read the identity data. The filter housing and the at least one filter cover thus enclose at least in some portions a filter interior in which the in particular high-temperature fluid flows during use. The carrier portion thus projects according to the invention from this in particular high-temperature fluid region in the filter interior and extends through the passage opening outward, i.e. in the direction of the read and/or write unit during use.

Because the carrier portion projects from the fluid region in the filter interior, the data store can be arranged outside the fluid region. In this way, it is achieved that the region between the data store and the outer side of the passage opening, i.e. during use the region between the data store and the read and/or write unit, is essentially free of fluid. This reduces fluid-related faults during the data transmission between the data store and the read and/or write unit and hence increases the operational safety of the filter device.

A data store arranged outside the fluid region has the further advantage that requirements for additional shielding measures for protecting the data store from the signal-compromising and in particular high-temperature fluid are reduced. This advantageously simplifies the structure of the data store and hence the structure of the filter device.

Because the carrier portion extends during use in the direction of the read and/or write unit, the data store can be arranged closer to the read and/or write unit. This advantageously stabilizes the data transmission between the data store and the read and/or write unit, for example when the identity data are read, such that the operational safety of the filter device is further increased.

In order to identify the filter element, during use the read and/or write unit wirelessly reads the identity data from the data store and identifies the filter element on the basis of the identity data read. By identifying the filter element, a check can advantageously be made as to whether a filter element is present or installed in the filter housing and/or whether the filter element is suitable for the specific required case. A check can also be made as to whether the installed filter element is an original manufacturer's filter element or an original replacement part.

A data store according to the invention is configured in such a way that, by means of the read and/or write unit, both data can be wirelessly read from the data store and data can be written, in particular wirelessly, to the data store.

A filter device according to the invention is designed for use in a mobile hydraulic system, in particular to filter hydraulic oil. For this purpose, the filter device can be arranged on and/or in a hydraulic tank. Other arrangements are possible. The invention can generally be used in connection with the filtering of fluids.

Preferred embodiments of the invention are specified in the dependent claims.

In a preferred embodiment of the invention, the carrier portion is arranged on an end side of the filter element. Arrangement on an end side makes it possible to arrange the data store at a greater distance from the signal-compromising, and in particular high-temperature, fluid in the center of the filter element at or in the carrier portion. Requirements for shielding measures to protect the data store from the fluid are consequently reduced such that the structure of the filter device is simplified.

The carrier portion preferably has a protuberance which extends at least partially through the passage opening in the filter housing and/or filter cover. The protuberance reduces the distance of the carrier portion from the outer side of the passage opening, i.e. during use from the read and/or write unit, such that the data store can be arranged closer to the read and/or write unit. As a result, the data transmission between the data store and the read and/or write unit is stabilized and the operational safety is thus further increased.

In a further preferred embodiment, the carrier portion seals the passage opening in the filter housing and/or filter cover fluidtightly. It is thus ensured that no fluid passes to the outside from the filter interior during operation. It is thus prevented, on the one hand, that fluid passes into the area between the data store and the read and/or write unit and consequently compromises the data transmission. On the other hand, the escape of fluid from the filter interior signals by implication the absence of the filter element, as a result of which operation without a filter element can be easily detected and thus avoided. In both cases, operational safety is increased.

The carrier portion is preferably formed from a material, for example plastic, the shielding effect of which is less than the shielding effect of the filter housing and/or filter cover. In other words, it is thus advantageous if the signal permeability of the material from which the carrier portion is formed is greater than the signal permeability of the filter housing and/or filter cover. This is because it stabilizes the data transmission between the data store and the read and/or write unit through the carrier portion, for example in the case of an arrangement of the data store in the carrier portion such that the operational safety is increased. Such a material can additionally advantageously reduce the weight of the carrier portion and facilitate the manufacture of the carrier portion.

For the smallest possible distance of the data store from the outer side of the passage opening, i.e. during use from the read and/or write unit, it is advantageous if the data store is arranged at least partially, in particular completely, in the passage opening. The small distance between the data store and the read and/or write unit stabilizes the data transmission and thus increases the operational safety.

In order to minimize the distance of the data store from the outer side of the passage opening, i.e. during use from the read and/or write unit, it is particularly advantageous if the data store is arranged at least partially, in particular completely, outside the filter housing and/or filter cover. The data store is thus preferably arranged on or in the carrier portion in such a way that it projects outward at least partially, in particular completely, from the passage opening in the filter housing and/or filter cover. The carrier portion can extend for this purpose through the passage opening to the outer side of the passage opening. By virtue of the minimized distance of the data store from the read and/or write unit during use, the data transmission is particularly stable and the operational safety particularly increased.

In a preferred embodiment of the invention, the data store is arranged on or in an end face of the carrier portion. In other words, the data store is arranged on or in an outer face, facing away from the fluid area, of the carrier portion. The carrier portion in this way shields the data store from the signal-compromising, and in particular high-temperature, fluid such that requirements for additional shielding measures to protect the data store from the fluid are reduced.

The carrier portion preferably has a closure cap for holding the data store, wherein the data store is arranged between the end face and the closure cap. The closure cap advantageously retains the data store on the carrier portion. The closure cap here preferably encloses a protected receptacle for the data store, as a result of which the risk of damage to the data store is reduced and thus the operational safety is further increased.

In order to facilitate the data transmission between the data store and the read and/or write unit through the closure cap, it is advantageous if the closure cap is formed from a material, for example plastic, the shielding effect of which is less than the shielding effect of the filter housing and/or filter cover.

In a preferred embodiment of the invention, the read or write unit can also be arranged outside the filter housing without forming a fixed connection to the filter housing or filter cover.

The filter housing and/or filter cover can preferably be connected to the read and/or write unit. Such a design of the filter device has the advantage that during use the read and/or write unit can be fixedly mounted on the filter device. As a result, in particular continuous data transmission between the data store and the read and/or write unit during the operation of the filter device is facilitated. The filter housing and/or the filter cover can for this purpose be connected to the read and/or write unit at the outer side of the passage opening in order to reduce during use the distance of the data store from the read and/or write unit.

The filter housing and/or the filter cover preferably has at the passage opening a connecting means for the connection, in particular form-fitting connection, in particular bayonet connection, to the read and/or write unit. This facilitates the mounting of the read and/or write unit on the filter housing and/or filter cover and ensures stable data transmission between the data store and the read and/or write unit through the passage opening.

Further data, in particular operating data and/or manufacturing data, can preferably be stored in a writable storage area of the data store. Manufacturing data, i.e. data which arise before or during the manufacture of the filter element, and/or operating data, i.e. data which arise after the manufacture of the filter element, in particular during operation, are stored in the data store. Such data can advantageously further increase the operational safety of the filter device by, for example, monitoring the exceeding of certain threshold values or calculating the remaining service life and/or lifetime of the filter element.

In order to facilitate the storage of data in the data store, it is advantageous if data can be written wirelessly to the data store by means of the read and/or write unit.

The data store preferably contains at least one wirelessly communicating data store, in particular an RFID transponder. Wirelessly communicating data stores, in particular RFID transponders, enable particularly simple and efficient data transmission. The operational safety is increased by the high reliability of the RFID transponder.

A subordinate aspect of the invention relates to a filter element for a filter device, in particular an above-described filter device. The filter element is adapted for arrangement in a filter housing and has at one end side a carrier portion with a protuberance which protrudes in the longitudinal direction of the filter housing. Arranged on or in the protuberance is a data store in which identity data for identifying the filter element are stored which can be read wirelessly from the data store by means of a read and/or write unit, wherein the protuberance of the carrier portion is arranged in centrally with respect to the filter element.

The filter element is accordingly disclosed and claimed both as part of the filter device and also independently from the filter device.

A further subordinate aspect of the invention relates to an arrangement of a filter device, in particular an above-described filter device, and a read and/or write unit. The filter device contains a filter housing, at least one filter cover, and at least one filter element which is arranged replaceable in the filter housing. The filter element has a carrier portion with at least one data store. The carrier portion extends at least partially through a passage opening in the filter housing and/or filter cover, wherein the data store is arranged on or in the carrier portion. Identity data for identifying the filter element are stored in the data store and can be read wirelessly from the data store by means of a read and/or write unit. The read and/or write unit is arranged at the passage opening in the filter housing and/or filter cover in order to identify the filter element, wherein the read and/or write unit is configured to read the identity data from the data store and to identify the filter element on the basis of the identity data read.

Thus, both the arrangement of the filter device and the read and/or write unit, i.e. the combination of the filter device and the read and/or write unit, and the filter device in its own right, i.e. independently of the read and/or write unit, are disclosed and claimed.

Lastly, a method for identifying a filter element using a filter device, in particular an above-described filter device, and a read and/or write unit is specified within the scope of the invention. The filter device contains a filter housing, at least one filter cover, and at least one filter element which is arranged replaceable in the filter housing and which has at least one carrier portion with at least one data store. The carrier portion extends at least partially through a passage opening in the filter housing and/or filter cover, wherein the data store is arranged on or in the carrier portion. Identity data for identifying the filter element are stored in the data store. The read and/or write unit is arranged at the passage opening in the filter housing and/or filter cover, wherein the read and/or write unit reads the identity data from the data store and identifies the filter element on the basis of the identity data read.

With respect to the features, the effect, and the advantages of the filter element, the arrangement, and the method, reference is made to the explanations in connection with the filter device and with the filter element.

Other features which are considered as characteristic for the invention are set forth in the appended claims.

Although the invention is illustrated and described herein as embodied in a filter device, a filter element, an arrangement, and a method for identifying a filter element, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, longitudinal sectional view of a filter device according to an exemplary embodiment according of the invention;

FIG. 2 is a perspective view of the filter device from FIG. 1;

FIG. 3 is a detailed, perspective view of a filter element of the filter device from FIG. 1;

FIG. 4 is a perspective view of a closure cap of the filter device from FIG. 1 with a data store and a coil for the transmission of energy and data;

FIG. 5 is an exploded, perspective view of a connection between the filter device from FIG. 1 and a read and/or write unit; and

FIG. 6 is an exploded, perspective view of the connection between a further filter device according to an exemplary embodiment according to the invention and a read and/or write unit.

### DETAILED DESCRIPTION OF THE INVENTION

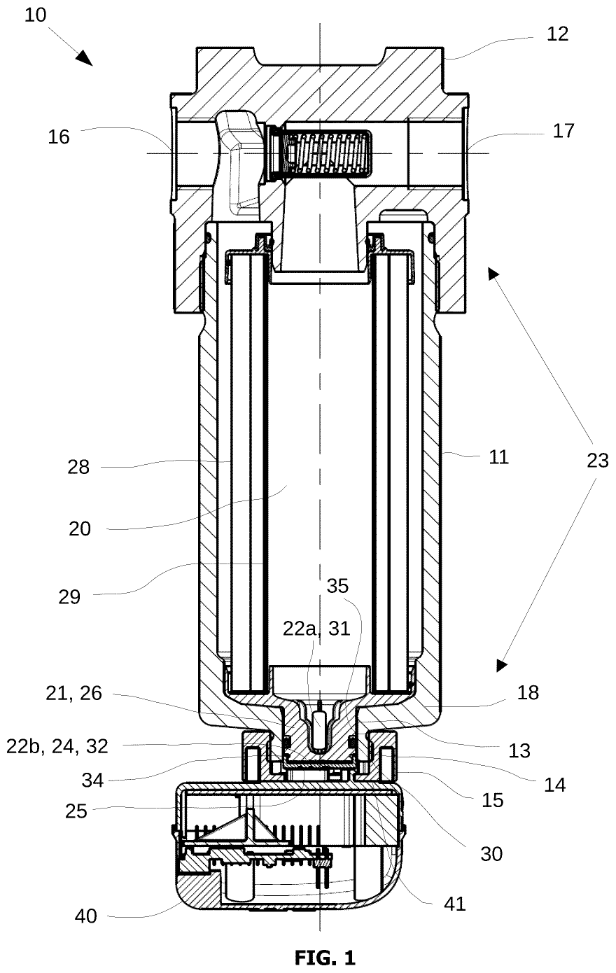

Referring now to the figures of the drawings in detail and first, particularly to FIG. 1 thereof, there is shown a longitudinal sectional view of a filter device 10 according to an exemplary embodiment according of the invention. The filter device 10 is configured to filter hydraulic oil in a mobile hydraulic system. Other applications are possible.

The filter device 10 includes a filter housing 11, a filter cover 12, and a filter element 20.

The filter housing 11 forms a cylindrical bowl with a longitudinal direction and an essentially circular housing base 18. The bowl-shaped filter housing 11 is closed by the filter cover 12 on a side situated opposite the housing base 18. The filter housing 11 and the filter cover 12 in this way form a filter interior for the fluid, wherein an inlet 16 for the fluid to be filtered and an outlet 17 for the filtered fluid are provided in the filter cover 12.

The filter element 20 is arranged replaceable in the filter housing 11, wherein the filter element 20 has an essentially cylindrical form and is arranged essentially coaxially in the filter housing 11. The filter element 20 contains an essentially hollow cylindrical filter material 28. The outside of the filter material 28 is here fluidically connected to the inlet 16 and the cavity enclosed by the filter material 28 is fluidically connected to the outlet 17. The filter element 20 can have other geometries and be arranged differently.

During use, the fluid, which in practice is usually hot, thus flows in the filter interior from the inlet 16, through the filter material 28, to the outlet 17.

The filter element 20 has a carrier portion 21 with a data store 22a, 22b which is arranged on the carrier portion 21. The data store 22a, 22b can also be arranged in the carrier portion.

Identity data for identifying the filter element 20 are stored in the data store 22a, 22b and can be read wirelessly from the data store 22 by means of a read and/or write unit 40. The identity data specify the filter element 20. For this purpose, the identity data can comprise data which enable identification only of the type of the filter element 20, for example a type designation. The identity data can also comprise data which allow identification of the individual filter element 20, for example a number which is assigned only once, i.e. is essentially unique. Such a number can be, for example, a consecutive manufacturing or identifying number of the data store 22a, 22b and/or of the filter element 20.

The carrier portion 21 extends at least partially through a passage opening 13 in the filter housing 11. Specifically, the carrier portion 21 extends through the passage opening 13 in an outward direction and ends essentially flush with an outer side of the passage opening 13. The carrier portion 21 thus extends, starting from the filter material 28, through the passage opening 13 in the filter housing 11, to the outer side of the passage opening 13. The carrier portion 21 in this way connects the filter material 28 to the outer side of the passage opening 13 and thus displaces in this area the fluid in the filter interior. The area between the data store 22a, 22b and the outer side of the passage opening 13 is thus essentially free of fluid.

The carrier portion 21 is arranged at an end side 23 of the filter element 20. Specifically, the carrier portion 21 is arranged at that end side 23 of the filter element 20 which faces away from the filter cover 12, and extends, starting from the end side 23, through the passage opening 13 which is formed in the housing base 18 of the filter housing 11. The carrier portion 21 can be arranged differently, for example at a different end side 23. The passage opening 13 can be formed at a different location, for example in the filter cover.

The carrier portion 21 has, on the side facing the filter material 28, an annular groove into which the filter material 28 is inserted. The carrier portion 21 in this way forms an end-side closure of the filter material 28, which closure supports the filter material 28 or filter element 20 in the filter housing 11.

The carrier portion 21 has a protuberance 26 which extends at least partially through the passage opening 13 in the filter housing 11. The protuberance 26 is for this purpose formed centrally with respect to the filter element 20 or essentially coaxially with the filter housing 11 and arranged on a side situated opposite the filter material 28. The protuberance 26 in this way projects from the filter material 28 in a longitudinal direction of the filter housing 11 and extends through the passage opening 13 to the outer side of the passage opening 13. The external shape of the protuberance 26 is here adapted to the internal shape of the passage opening 13 such that the passage opening 13 is essentially free of fluid. The protuberance 26 thus forms a plug which engages in the passage opening 13 and hence displaces fluid from the passage opening 13. The protuberance can have other geometries.

The carrier portion 21 seals the passage opening 13 in the filter housing 11 fluidtightly. For this purpose, the carrier portion 21 has a sealing means 30. The sealing means 30 forms a sealing ring which is arranged radially peripherally at the protuberance 26 and interacts in sealing fashion with the inner surface of the passage opening 13. The sealing means can take a different form.

The carrier portion 21 is formed from plastic. The carrier portion 21 can be formed from different materials.

FIG. 1 discloses two different arrangements of the data store 22a, 22b on the carrier portion 21, wherein the data store 22a, 22b is arranged either on a side of the carrier portion 21 facing the filter interior (labeled with the lower-case a) or on a side of the carrier portion 21 facing away from the filter interior (labeled with the lower-case b). The data store 22a, 22b can be fixed to the carrier portion 21, for example by adhesive bonding or welding. The data store 22a, 22b can, however, also be arranged in the carrier portion 21, i.e. installed, for example embedded or injection-molded, integrally in the carrier portion 21.

According to the first data store arrangement, the data store 22a is arranged on the carrier portion 21 and completely in the passage opening 13. The carrier portion 21 has for this purpose, on a side facing the filter element 20, a recess 31 in which the data store 22a is arranged. The recess 31 is formed in the protuberance 26 in the longitudinal direction of the filter housing 11 such that it extends in the direction of the outer side of the passage opening 13.

According to the second data store arrangement, the data store 22b is likewise arranged on the carrier portion but at least partially outside the filter housing 11. The data store 22b thus projects completely from the passage opening 13 and is hence arranged at the outer side of the passage opening 13.

Specifically, the data store 22b is arranged on an end face 24 of the carrier portion 21. The end face 24 is here arranged at the protuberance 26 on a side situated opposite the filter element 20, specifically at the tip of the protuberance 26. The end face 24 ends flush with the outer side of the passage opening 13. In this way, the data store 22b arranged on the end face 24 projects from the passage opening 13. The data store 22b can also be arranged in the end face 24.

The carrier portion 21 has a closure cap 25 for holding the data store 22b, wherein the data store 22b is arranged between the end face 24 and the closure cap 25. For this purpose, an indentation 34 radially encircling the end face 24 and which is in form-fitting engagement with the closure cap 25 is formed on the carrier portion 21, specifically on the protuberance 26.

The closure cap 25 is manufactured from plastic. The closure cap 25 can be manufactured from different materials.

The filter housing 11 can be connected to the read and/or write unit 40, wherein in FIG. 1 the read and/or write unit 40 is connected to the filter device 10.

The filter device 10 is thus disclosed and claimed both in a state connected to the read and/or write unit 40 and also per se, i.e. independently of the read and/or write unit 40.

The read and/or write unit 40 is connected to the filter housing 11 at the outer side of the passage opening 13. For this purpose, the filter housing 11 has at the passage opening 13 a connecting means 14 for the bayonet connection to the read and/or write unit 40. The connecting means 14 forms for this purpose an annular protuberance with an external hex through which the passage opening 13 extends centrally. A mating connecting means 41 of the read and/or write unit 40 engages in form-fitting fashion in undercuts 35 of the connecting means 14 such that the filter housing 11 is connected to the read and/or write unit 40. The connection between the filter housing 11 and the read and/or write unit 40 can take a different form.

The read and/or write unit 40 takes the form of a read and/or write apparatus which is specially designed for this use case. The read and/or write unit 40 can also be, for example, a smartphone, laptop, or the like with a suitable application program.

Further data, in particular operating data and/or manufacturing data, can be stored in a writable storage area of the data store 22a, 22b. Specifically, manufacturing data, such as for example a manufacturing date or an order number, can be stored in the data store 22a, 22b. In addition, operating data, such as for example the date of initial operation or data from sensors, for example temperature sensors or pressure sensors, which capture measured values in or at the filter element 20 are stored in the data store 22a, 22b.

Data can be written wirelessly to the data store 22a, 22b by means of the read and/or write unit 40. The read and/or write unit 40 can thus send data to the data store 22a, 22b which are received by the data store 22a, 22b and stored in the data store 22a, 22b.

The data store 22a, 22b contains a wirelessly communicating data store 22a, 22b, specifically an RFID transponder. The data store 22a, 22b can include different data stores 22a, 22b.

The data in the data store are partially or completely stored in a form encrypted by means of a cryptographic method, i.e. as ciphertext. Alternatively or additionally, the data in the data store can be provided partially or completely with a digital signature.

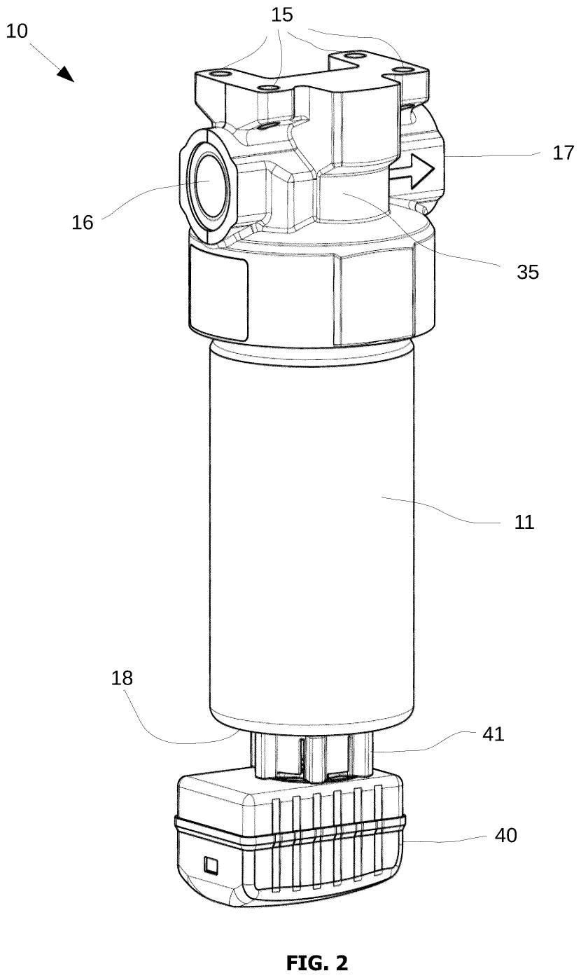

FIG. 2 shows a perspective view of the filter device 10 from FIG. 1. The cylindrical geometry of the filter housing 11 is clear. The inlet 16 for the fluid to be filtered and the outlet 17 for the filtered fluid in the filter cover 12 can be clearly seen (labelled by the outwardly directed arrow).

Attachment means 15, for example screw holes, by means of which the filter device 10 can be mounted on a mobile hydraulic system are provided on the filter cover 12. The filter device 10 is thus mounted on the mobile hydraulic system by the filter cover 12 such that the read and/or write unit 40 is connected to the filter device 10 on a side facing away from the mobile hydraulic system.

The read and/or write unit 40 is connected to the filter housing 11 at the housing base 18. The mating connecting means 41 which interacts in form-fitting fashion with the connecting means 14 of the filter housing 11 can be clearly seen.

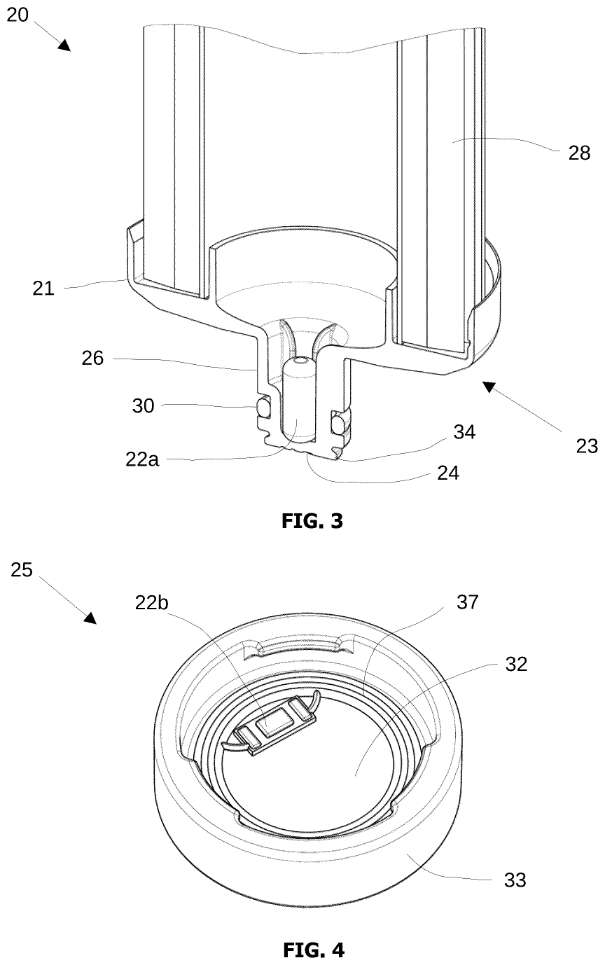

FIG. 3 shows a longitudinal section of the filter element 20 from FIG. 1. The end side 23 of the filter element 20 at which the carrier portion 21 is arranged is shown.

The data store 22a is shown in accordance with the first data store arrangement, i.e. on a side of the carrier portion 21 facing the filter interior. The data store 22a is thus arranged in the recess 31 of the carrier portion 21 which extends, starting from the filter interior, specifically from the cylindrical cavity inside the filter material 28, in the protuberance 26 in the direction of the end face 24. The data store 22a is thus fixed on the carrier portion 21.

The annular sealing means 30 can be clearly seen at the outer side of the protuberance 26. The indentation 34, radially encircling the end face 24, of the carrier portion 21, specifically of the protuberance 26, can be seen.

FIG. 4 shows a perspective illustration of the closure cap 25 of the filter device 10 from FIG. 1 with the data store 22b and a coil 37 for the transmission of energy and data. In contrast to FIG. 3, the data store 22b is now shown in accordance with the second data store arrangement, i.e. on a side of the carrier portion 21 facing away from the filter interior.

The closure cap 25 takes the form of an essentially cylindrical bowl with an essentially circular base 32 and a peripheral side wall 33. The data store 22b is arranged in the closure cap 25. The data store 22b is fixed to the base 32 of the closure cap 25. Provided on the inside of the side wall 33 are connecting means which are adapted to interact in a form-fitting fashion with the indentation 34 of the carrier portion 21 in order to connect the closure cap 25 to the carrier portion 21. If the closure cap 25 is connected to the protuberance 26 in this way, the data store 22b is arranged on the carrier portion 21, specifically on the end face 24 of the carrier portion 21. The closure cap 25 thus encloses with the end face 24 of the carrier portion 21 a protected receptacle in which the data store 22b is arranged.

The data store 22b is thus retained, in particular during operation, on the carrier portion 21 by the closure cap 25 and protected from damage by external influences.

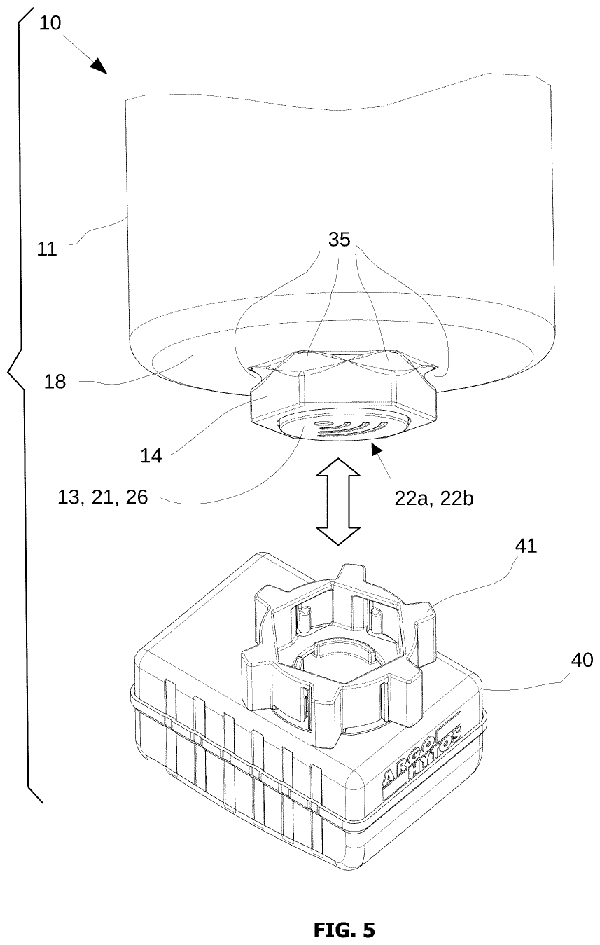

Shown in FIG. 5 is a detailed illustration of the connection between the filter device 10 from FIG. 1 and the read and/or write unit 40. The annular connecting means 14 which projects from the housing base 18 as an external hex can be clearly seen. The undercuts 35 which are formed between the housing base 18 and the edges, extending away from the housing base 18, of the hexagonal external geometry of the connecting means 14 can be seen in particular. The connecting means 14 in this way surrounds the passage opening 13 through which extends the carrier portion 21 on which the data store 22a, 22b is arranged.

The mating connecting means 41 of the read and/or write unit 40 forms essentially a connecting ring which is adapted to interact in form-fitting fashion with the undercuts 35 of the connecting means 14.

In order to connect the read and/or write unit 40 to the connecting means 14 of the filter housing 11, the mating connecting means 41 is pushed over the connecting means 14 and then twisted relative to the connecting means 14 such that it engages in form-fitting fashion with the undercuts 35.

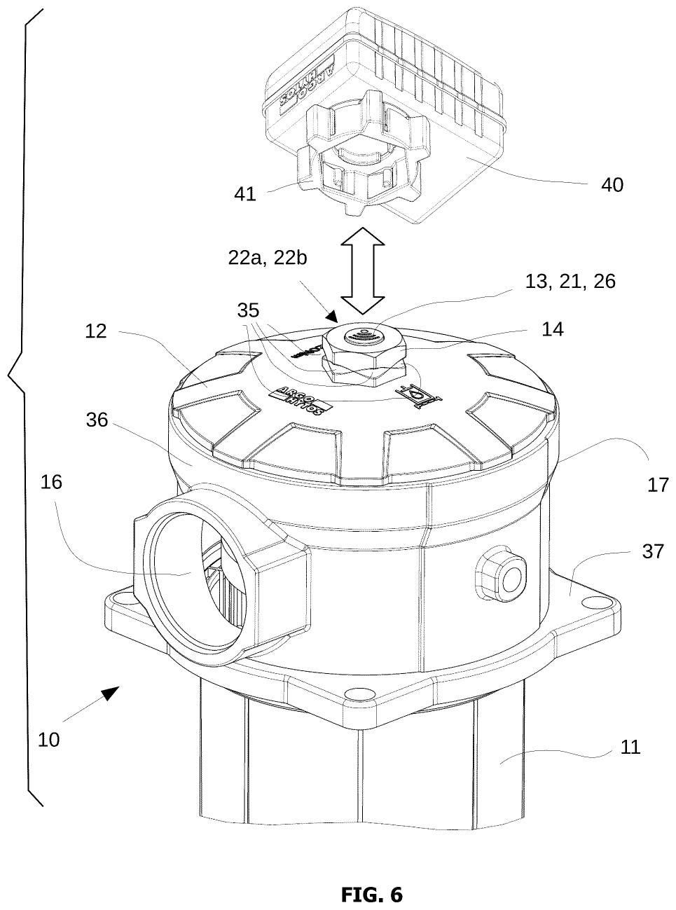

FIG. 6 shows a detailed illustration of the connection between a further filter device 10 according to an exemplary embodiment according to the invention and the read and/or write unit 40.

The filter device 10 from FIG. 6 differs from the filter device 10 from FIGS. 1 to 5, on the one hand, in that a carrier portion 21 extends through a passage opening 13 in a filter cover 12 and not in a filter housing 11. The carrier portion 21 which, analogously to the filter device 10 from FIGS. 1 to 5, has a data store 22a, 22b with identity data of a filter element 20 arranged in the filter housing 11, thus extends from an end side 23, facing the filter cover 12, of the filter element 20, through the passage opening 13 in the filter cover 13, to the outside. The read and/or write unit 40 can be connected to the filter cover 12 at the outer side of the passage opening 13.

On the other hand, the filter cover 12 is connected to a filter head 36 and not to the filter housing 11. The filter head 36 has an essentially tubular geometry, wherein the filter cover 12 closes the tubular filter head 36 on one side. The filter head 36 is connected to the open side of the bowl-shaped filter housing 11 on a side situated opposite the filter cover 36 by means of a flange. The filter housing 11, the filter head 36, and the filter cover 12 in this way form a filter interior for the fluid, wherein an inlet 16 for the fluid to be filtered and an outlet 17 for the filtered fluid are provided in the filter head 36. The functionality of identifying the filter element 20 using the filter device 10 and the read and/or write unit 40 will be explained in detail below on the basis of the exemplary embodiments from FIGS. 1 to 6.

During use, the read and/or write unit 40 is arranged at the outer side of the passage opening 13 and wirelessly reads the identity data from the data store 22a, 22b which is arranged on or in the carrier portion 21. Because the carrier portion 21 projects from the fluid area in the filter interior and extends through the passage opening 13 in the direction of the read and/or write unit 40, both fluid between the data store 22a, 22b and the read unit 40 is avoided and the distance of the data store 22a, 22b from the read unit 40 is reduced such that the reading of the identity data takes place in a particularly stable fashion.

As soon as the identity data are read from the data store 22a, 22b, the identification of the filter element 20 takes place by the read and/or write unit 40. Decryption of the encrypted identity data, i.e. conversion of ciphertext into plain text, can thus take place. For this purpose, the read and/or write unit 40 can comprise the key required for the decryption. Alternatively or additionally, the read and/or write unit 40 can carry out a check of a digital signature of the identity data. In order to check the integrity of the identity data, the read and/or write unit 40 can calculate a checksum. The decrypted identity data specify the filter element 20 in such a way that the read and/or write unit 40 can finally identify the filter element 20.

A check can be made by means of the identification as to whether a filter element 20 is present or installed in the filter housing 11 and/or whether the filter element 20 is suitable for the specific required case. A check can also be made as to whether the installed filter element 20 is an original manufacturer's filter element 20 or an original replacement part. The check can be made, for example, by the read and/or write unit 40. For this purpose, the read and/or write unit 40 can be connected to a database in order, for example, to verify the identity data. The read and/or write unit 40 can also produce proof of origin offline by means of a cryptographic method. The check can also be made by a separate control unit which can be connected to the read and/or write unit 40 so that data can be transmitted. The check can also be made indirectly by a human being, for example by means of a smartphone with NFC technology.

The filter element 20 can be identified both in a state installed in the filter housing 11 and in a state removed from the filter housing 11. The filter element 20 can thus be identified during manufacture in order to save it, for example, in a database even before it is installed in the filter housing 11. The identification of the filter element 20 can also take place before or during the operation and during the maintenance of a mobile hydraulic system or a similar application in which the filter device 10 with the filter element 20 is installed.

The following is a summary list of reference numerals and the corresponding structure used in the above description of the invention:
10 filter device
11 filter housing
12 filter cover
13 passage opening
14 connecting means
15 attachment means
16 inlet
17 outlet
18 housing base
filter element
21 carrier portion
22a, 22b data store
23 end side
24 end face
closure cap
26 protuberance
28 filter material
29 support tube
30 sealing means
31 recess
32 base
33 side wall
34 indentation
undercuts
36 filter head
37 coil
40 read and/or write unit
41 mating connecting means

1. A filter device for filtering fluids, the filter device comprising:
a filter housing;
at least one filter cover, at least one of said filter housing and/or said at least one filter cover having a passage opening formed therein;
a read and/or write unit; and
at least one filter element disposed replaceably in said filter housing and having a carrier portion with at least one data store, wherein identity data are stored in said at least one data store and being read wirelessly from said at least one data store by means of said read and/or write unit, said carrier portion extending at least partially through said passage opening in said filter housing and/or said at least one filter cover, wherein said at least one data store is disposed on or in said carrier portion.

2. The filter device according to claim 1, wherein said carrier portion is disposed on an end side of said at least one filter element.

3. The filter device according to claim 1, wherein said carrier portion has a protuberance which extends at least partially through said passage opening in said filter housing and/or said at least one filter cover.

4. The filter device according to claim 1, wherein said carrier portion seals said passage opening in said filter housing and/or said at least one filter cover fluidtightly itself or by means of a seal.

5. The filter device according to claim 1, wherein said carrier portion is formed from a material that has a shielding effect which is less than the shielding effect of said filter housing and/or said at least one filter cover.

6. The filter device according to claim 1, wherein said at least one data store is disposed at least partially in said passage opening.

7. The filter device according to claim 1, wherein said at least one data store is disposed at least partially outside said filter housing and/or said at least one filter cover.

8. The filter device according to claim 1, wherein said at least one data store is disposed on or in an end face of said carrier portion.

9. The filter device according to claim 8, wherein said carrier portion has a closure cap for holding said at least one data store, wherein said a least one data store is disposed between said end face and said closure cap.

10. The filter device according to claim 9, wherein said closure cap is formed from a material that has a shielding effect which is less than the shielding effect of said filter housing and/or said at least one filter cover.

11. The filter device according to claim 1, wherein said read or write unit is disposed outside of said filter housing without forming a fixed connection to said filter housing and/or said at least one filter cover.

12. The filter device according to claim 1, wherein said filter housing and/or said at least one filter cover is connected to said read and/or write unit.

13. The filter device according to claim 12, wherein said filter housing and/or said at least one filter cover has at said passage opening a connecting means for a connection to said read and/or write unit.

14. The filter device according to claim 1, wherein further data, including operating data and/or manufacturing data, is stored in a writable storage area of said at least one data store.

15. The filter device according to claim 1, wherein data is written wirelessly to said at least one data store by means of said read and/or write unit.

16. The filter device according to claim 1, wherein said at least one data store contains at least one wirelessly communicating data store.

17. A filter element for a filter device, the filter element comprising:
a filter element body adapted for arrangement in a filter housing of the filter device, said filter element body having at one end side a carrier portion with a protuberance which protrudes in a longitudinal direction of the filter housing; and
a data store disposed on or in said protuberance and storing identity data for identifying the filter element which are read wirelessly from said data store by means of a read and/or write unit, wherein said protuberance of said carrier portion is disposed centrally with respect to said filter element body.

18. A filter device configuration, comprising:
a read and/or write unit; and
a filter device containing:
a filter housing;
at least one filter cover, a least one of said filter housing and/or said at least one filter cover having a passage opening formed therein;
at least one filter element disposed replaceably in said filter housing and having a carrier portion with at least one data store, said carrier portion extending at least partially through said passage opening in said filter housing and/or said at least one filter cover; and
a data store disposed on or in said carrier portion, and identity data for identifying said at least one filter element are stored in said data store and is read wirelessly from said data store by means of said read and/or write unit, and said read and/or write unit is disposed at said passage opening in said filter housing and/or said at least one filter cover in order to identify said at least one filter element, wherein said read and/or write unit is configured to read the identity data from said data store and to identify said at least one filter element on a basis of the identity data read.

19. A method for identifying a filter element using a filter device and a read and/or write unit, wherein the filter device contains a filter housing, at least one filter cover, and at least one filter element which is disposed replaceably in the filter housing and which has at least one carrier portion with at least one data store, and the at least one carrier portion extending at least partially through a passage opening in the filter housing and/or the at least one filter cover, wherein the at least one data store is disposed on or in the least one carrier portion, and identity data for identifying the at least one filter element are stored in the at least one data store, and the read and/or write unit is disposed at the passage opening in the filter housing and/or the at least one filter cover, wherein the read and/or write unit reads the identity data from the at least one data store and identifies the at least one filter element on the basis of the identity data read.
